(19) United States
(12) Patent Application Publication
(10) Pub. No.: US 2008/0165647 A1
(43) Pub. Date: Jul. 10, 2008

(54) Recording/reproducing apparatus, recording/reproducing method, and information storage medium therefor

(75) Inventors: Joon-hwan KWON, Suwon-si (KR); Kyung Geun Lee, Seongnam-si (KR); Sung Hee Hwang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/782,855

(22) Filed: Jul. 25, 2007

(30) Foreign Application Priority Data
Jan. 9, 2007 (KR) 2007-2687

(51) Int. Cl. G11B 7/00

(52) U.S. Cl. 369/53.17

(57) ABSTRACT

A recording/reproducing apparatus and a method of easily managing a defect in a multi-layer information storage medium, and an information storage medium therefor. The information storage medium includes a user data area for recording user data, and a spare area for recording replacement data, which replaces a defective data block when a defect occurs in data recorded in the user data area, wherein the replacement data is recorded in the same recording layer that the defective data block is recorded.

### CROSS-REFERENCE TO RELATED APPLICATION

This application claims the benefit of Korean Patent Application No. 2007-2687, filed in the Korean Intellectual Property Office on Jan. 9, 2007, the disclosure of which is incorporated herein by reference.

### BACKGROUND OF THE INVENTION

1. Field of the Invention

Aspects of the present invention relate to a recording/reproducing apparatus and a method of easily managing a defect of a multi-layer information storage medium and an information storage medium therefor.

2. Description of the Related Art

A defect management method can stably record data by recording/reproducing the data in a spare area when a defect occurs in a user data area while allocating the spare area in a recording/re-recording disc, such as DVD+RW/DVD-RAM/BD-RE/BD-R. BD refers here to a Blu-ray disc.

FIG. 1A illustrates the correspondence between defective data block blocks 131 and 171 and replacement data blocks 141 and 142. FIG. 1B illustrates a defect list 100 for management of a defect. A two-layer disc is formed of two recording layers, a layer 0 (L0) and a layer 1 (L1). The L0 includes a lead in area 110, an inner spare area (ISA) 0 120, a user data area 130, an outer spare area (OSA) 0 140, and an outer area 150. The L1 includes the outer area 150, an OSA 1 160, a user data area 170, an ISA 1 180, and a lead out area 190. The lead in area 110 and the outer area 150 are areas for storing disc management information and system information required in reproduction/recording. The spare areas, the ISA 0 120, the OSA 0 140, the OSA 1 160, and the ISA 1 180 are recording/reproducing areas that can replace defects in the user data areas 130 and 170, such as defective data block blocks 131 and 171.

If the defective data block 131 is detected while recording data in the user data area 130, the replacement data block 141 is recorded in the OSA 0 140 to substitute for the defective data block 131. If the defective data block 171 is detected while recording data in the user data area 170, the replacement data block 142 is recorded in the OSA 0 140 to substitute for the defective data block 171. According to the conventional method of allocating replacement data, when a defect occurs, the replacement data is allocated to the lowest available address in the spare areas. Accordingly, as illustrated in FIG. 1A, the replacement data block 142, which substitutes for (replaces) the defective data block 171 in L1, is allocated to the OSA 0 in L0. It is possible, as seen in FIG. 1A, for defective data blocks and the corresponding replacement data to be recorded in different recording layers.

Information about the defective data blocks 131 and 171 and the replacement data blocks 141 and 142 can be recorded in the lead in area 110, the outer area 150, and the lead out area 190. A defect list 100 includes a defect list header 101, defect list entries 102, and a defect list terminator 103. The defect list header 101 contains information about the defect list 100. The defect list terminator 103 shows termination of the defect list 100. The defect list entries 102 contain at least one defect list entry. Each defect list entry includes a defective data block address and a replacement data address.

In conventional defect management, the defect list 100 does not classify between recording layers, which results in several disadvantages. First, if a defective data block and a replacement data block are not in the same recording layer and data needs to be continuously recorded or reproduced, then an optical pickup must move to a recording layer including the replacement data block, record/reproduce data of the replacement data block, and move to a block next to the defective data block in order to reproduce/record the block next to the defective data block. Hence, at least two layer jumps are required. The layer jumps may take anywhere from several tens to several hundreds of milliseconds.

Second, the size of the defect list increases, since the defect management information needs to include information about defects in all recording layers. Accordingly, when a new defective data block occurs, it is time consuming to re-organize the defect list and to check whether a block that is to be recorded/reproduced is registered in the defect list. By forming a defect list for all the recording layers, the capacity of a disc increases, and as the number of recording layers increases, the checking time, the list re-organizing time, and the amount of calculations increases.

### SUMMARY OF THE INVENTION

Aspects of the present invention provide recording/reproducing apparatus and method of easily managing a defect in a multi-layer information storage medium, and an information storage medium therefor.

According to an aspect of the present invention, an information storage medium used by a recording and/or reproducing apparatus is provided, having a plurality of recording layers. The information storage medium includes: a user data area to record user data; and a spare area to record replacement data, which replaces defective data block detected in the user data area, wherein the replacement data is recorded in the same recording layer as the defective data block.

According to another aspect of the present invention, defect information containing information about the defective data block and the replacement data is formed in each recording layer and recorded in at least one recording layer.

According to another aspect of the present invention, the defect information includes information about the recording layer in which the defect information is recorded.

According to another aspect of the present invention, the defect information includes: an identifier of a defect list; a layer number of the defect list; and at least one defect list entry, wherein each defect list entry comprises address information regarding the defective data block and the replacement data.

According to another aspect of the present invention, the information storage medium is a write-once information storage medium and the information storage medium further includes a temporary disc management area for a temporary disc management; temporary defect information about the defective data block and the replacement data is recorded in the same recording layer that the defective data block is detected; and the temporary disc management area comprises address information regarding the temporary defect information in each recording layer.

According to another aspect of the present invention, the temporary disc management area includes a temporary disc management structure (TDMS) update unit as temporary disc management information; and the TDMS update unit includes a temporary defect list having temporary defect information regarding a certain recording layer, and a temporary disc definition structure having a pointer indicating a location of the last temporary defect list of each recording layer.

According to another aspect of the present invention, a recording apparatus is provided to record data in an information storage medium having a plurality of recording layers each including a user data area to record user data and a spare area to record replacement data that a replaces defective data block when a defect occurs in data recorded in the user data area. The recording apparatus includes a write unit to write data in the information storage medium; and a controller to control the write unit to write the replacement data in the same recording layer as the defective data block.

According to another aspect of the present invention, the controller further controls the write unit so that defect information containing information about the defective data block and the replacement data is formed in each recording layer and recorded in at least one recording layer.

According to another aspect of the present invention, the controller inserts information about the recording layer in which the defect information is recorded in the defect information.

According to another aspect of the present invention, the controller inserts an identification of a defect list, a layer number of the defect list, and at least one defect list entry in the defect information, and inserts address information regarding the defective data block and the replacement data in each defect list entry.

According to another aspect of the present invention, the information storage medium is a write-once information storage medium and further includes a temporary disc management area for a temporary disc management; and the controller controls the write unit so that temporary defect information containing information about the defective data block and the replacement data is recorded in the same recording layer that the defective data block is recorded, and address information regarding the temporary defect information regarding each recording layer is recorded in the temporary disc management area.

According to another aspect of the present invention, the controller further controls the write unit to record a temporary disc management structure (TDMS) update unit in the temporary disc management area as temporary disc management information, and the controller inserts into the TDMS update unit a temporary defect list comprising temporary defect information regarding one of the plurality of recording layers and a temporary disc definition structure comprising a pointer indicating a location of the last temporary defect list of each recording layer.

According to another aspect of the present invention, a reproducing apparatus is provided to reproduce data in an information storage medium having a plurality of recording layers, each including a user data area to record user data and a spare area to record replacement data that replaces a defective data block when a defect occurs in data recorded in the user data area. The reproducing apparatus includes a read unit to read data from the information storage medium; and a controller to control the read unit to read replacement data corresponding to defective data block from the same recording layer having the defective data block if the data that is to be reproduced is in the defective data block.

According to another aspect of the present invention, the controller obtains information about the recording layer in which the defect information is recorded from the defect information.

According to another aspect of the present invention, the controller obtains an identification of a defect list, a layer number of the defect list, and at least one defect list entry from the defect information, and obtains address information regarding the defective data block and the replacement data from the defect list entry.

According to another aspect of the present invention, the information storage medium is a write-once information storage medium and further includes a temporary disc management area for a temporary disc management; and the controller further controls the read unit so that temporary defect information containing information about the defective data block and the replacement data is read from the same recording layer having the defective data block, and address information regarding the temporary defect information for each recording layer is read from the temporary disc management area.

According to another aspect of the present invention, the controller further controls the read unit so that a temporary disc management structure (TDMS) update unit is read from the temporary disc management area as temporary disc management information; and the controller obtains, from the TDMS update unit, a temporary defect list including temporary defect information regarding one of the plurality of recording layers and a temporary disc definition structure including a pointer indicating a location of the last temporary defect list of each recording layer.

According to another aspect of the present invention, a recording method is provided that records data in an information storage medium having a plurality of recording layers, each including a user data area to record user data and a spare area to record replacement data that replaces a defective data block when a defect occurs in data recorded in the user data area. The recording method includes detecting data defective data block from the user data area; and recording the replacement data in the same recording layer as the defective data block.

According to another aspect of the present invention, a reproducing method is provided that reproduces data in an information storage medium having a plurality of recording layers, each including a user data area to record user and a spare area to record replacement data that replaces a defective data block when a defect occurs in data recorded in the user data area. The reproducing method includes reading replacement data corresponding to a defective data block from the same recording layer having the defective data block, when data that is to be reproduced is from the defective data block.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates correspondences between defective data blocks and substitution data blocks;

FIG. 1B illustrates a defect list for management of a defect;

FIG. 2 illustrates a layout of a rewritable disc according to an embodiment of the present invention;

FIG. 3 illustrates a layout of a write-once disc according to an embodiment of the present invention;

FIG. 4 illustrates a defect list according to an embodiment of the present invention;

FIG. 5 illustrates a temporary disc management structure (TDMA) according to an embodiment of the present invention;

FIG. 6 illustrates a temporary disc definition structure (TDDS) illustrated in FIG. 5 according to an embodiment of the present invention;

FIG. 7 is a schematic drawing of a recording/reproducing apparatus according to an embodiment of the present invention;

FIG. 8 is a diagram illustrating in detail the recording/reproducing apparatus illustrated in FIG. 7;

FIG. 9 is a flowchart illustrating a recording method according to an embodiment of the present invention; and

FIG. 10 is a flowchart illustrating a reproducing method according to an embodiment of the present invention.

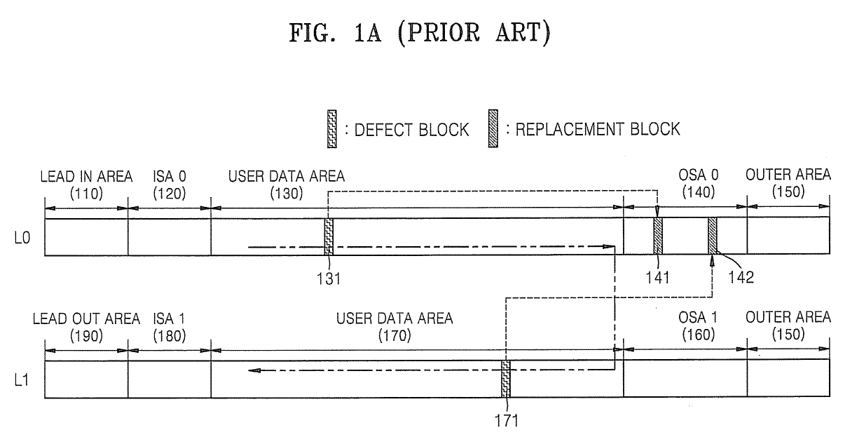

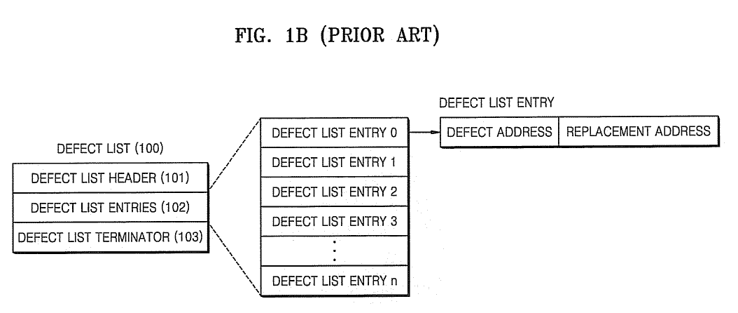

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to aspects of the present invention, a spare area for a replacement data block, which replaces a defective data block, is allocated to inner and/or outer parts of each recording layer of an information storage medium formed of a plurality of recording layers. When a defective data block is detected, the defective data block is replaced with a replacement data block that is not being used in a spare area of the same recording layer. If a defective data block that is not registered in a defect list is detected during reproduction/recording in the information storage medium, the defective data block is allocated with a block that is not being used in the spare area in the same recording layer and is registered in the defect list of the corresponding recording layer. All defective data blocks and replacement data blocks are located in the same recording layer.

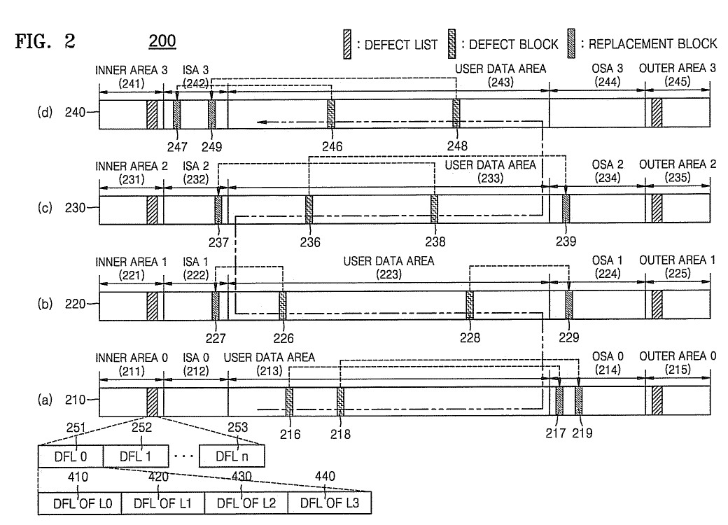

FIG. 2 illustrates a layout of a rewritable disc 200 according to an embodiment of the present invention. The rewriteable disc 200 includes four layers, (a), (b), (c), and (d): a zero recording layer (L0) 210, a first recording layer (L1) 220, a second recording layer (L2) 230, and a third recording layer (L3) 240.

The L0 210 includes an inner area 0 211, an inner spare area (ISA) 0 212, a user data area 213, an outer spare area (OSA) 0 214, and an outer area 0 215. The L1 220 includes an inner area 1 221, an ISA 1 222, a user data area 223, an OSA 1 224, and an outer area 1 225. The L2 230 includes an inner area 2 231, an ISA 2 232, a user data area 233, an OSA 2 234, and an outer area 2 235. The L3 240 includes an inner area 3 241, an ISA 3 242, a user data area 243, an OSA 3 244, and an outer area 3 245.

In the rewritable disc 200, a replacement data block that replaces a defective data block is recorded in the same recording layer of the defective data block. A replacement data block substituting for a defective data block generated in L0 210 is recorded in L0 210, a replacement data block substituting for a defective data block generated in L1 220 is recorded in L1 220, a replacement data block substituting for a defective data block generated in L2 230 is recorded in L2 230, and a replacement data block substituting for a defective data block generated in L3 240 is recorded in L3 240. A replacement data block can be recorded in an inner spare area in an inner part of a layer (such as ISA 1 222) or an outer spare area in an outer part of a layer (such as OSA 1 224.)

A replacement data block 217 and a replacement data block 219 are recorded in the OSA0 214 of L0 210. The replacement data blocks 217 and 219 substitute for a defective data block 216 and a defective data block 218 detected in the user data area 213 of L0 210, respectively. A replacement data block 227 and a replacement data block 229 are recorded in the ISA1 222 and OSA1 224 of L1 220, respectively. The replacement data blocks 227 and 229 substitute for a defective data block 226 and a defective data block 228 detected in the user data area 223 of L1 220, respectively. A replacement data block 237 and a replacement data block 239 are recorded in the OSA2 234 and ISA2 232 of L2 230, respectively. The replacement data blocks 237 and 239 substitute for a defective data block 236 and a defective data block 238, respectively, detected in the user data area 233 of L2 230. A replacement data block 247 and a replacement data block 249 are recorded in the ISA3 242 of L3 240, respectively. The replacements data blocks 247 and 249 substitute for a defective data block 246 and a defective data block 248 detected in the user data area 243 of L3 240, respectively.

The defect information containing information about a defective data block and a replacement data block, i.e., a defect list, is recorded in an inner area and an outer area of each recording layer. A defect list (DFL) 400 is recorded in the inner area 211 of L0 210. The DFL 400 includes DFL0 251, DFL1 252, through DFLn 253, which are defect lists containing the same contents. The DFLs 251-253 are repeatedly included in order to increase the reliability of information. Other aspects of the invention may include only one DLF in the DFL 400. The DFL0 251 includes a DFL of L0 410, a DFL of L1 420, a DFL of L2 430, and a DFL of L3 440. The DFL 400 separately manages a DFL of each recording layer. Accordingly, when a defect list of the L2 230 needs to be updated, only the DFL of L2 430 is updated.

According to the conventional technology, defect entries of all the recording layers are managed by one defect list without any classification between recording layers, and thus, a relatively large defect list should be changed and then re-recorded as compared to the DFL 400. When forming the conventional defect list, massive memory management is required while arranging the conventional defect list in order to add a defect list entry into a memory. However, the defect list 400 is independently managed according to each recording layer and thus, changing, deleting, and adding of a defect list entry is easy, and required memory is small.

The same DFLs are recorded in all of the recording layers L0 210 to L3 240. In other words, in order to update a defect list of L2 230, the DFL of L2 430 is updated, and the content of the update is applied to the other recording layers L1 220 to L3 240 in order to guarantee the reliability of information. According to other aspects of the invention, instead of recording the DFLs of each of the recording layers L0 210 to L3 240 in all of the recording layers L0 210 to L3 240 as illustrated in FIG. 2, a DFL corresponding to that recording layer can be recorded in each recording layer. Accordingly, the space for storing a defect list can be reduced. However, in this case, a defect list for a recording layer can only be found in that recording layer.

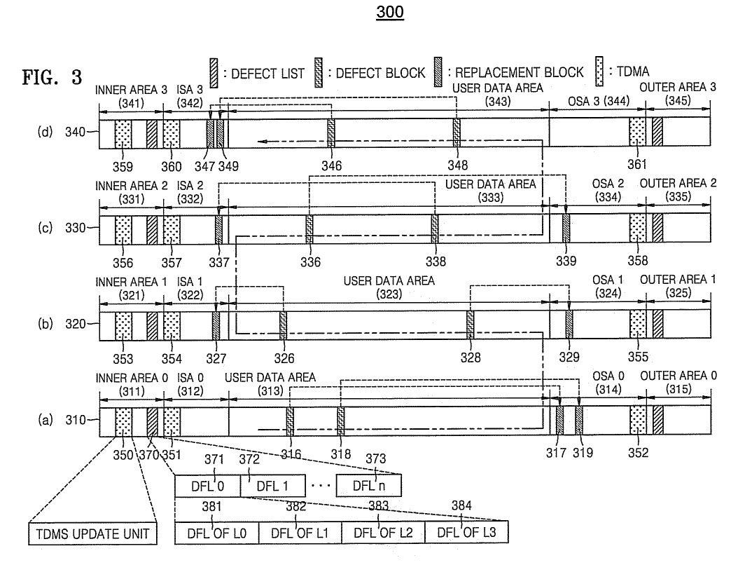

FIG. 3 illustrates a layout of a write-once disc 300 according to an embodiment of the present invention. The write-once disc 300 has four layers, (a), (b), (c) and (d), respectively: a zero recording layer (L0) 310, a first recording layer (L1) 320, a second recording layer (L2) 330, and a third recording layer (L3) 340.

The L0 310 includes an inner area 0 311, an inner spare area (ISA) 0 312, a user data area 313, an outer spare area (OSA) 0 314, and an outer area 0 315. The L1 320 includes an inner area 1 321, an ISA 1 322, a user data area 323, an OSA 1 324, and an outer area 1 325. The L2 330 includes an inner area 2 331, an ISA 2 332, a user data area 333, an OSA 2 334, and an outer area 2 335. The L3 340 includes an inner area 3 341, an ISA 3 342, a user data area 343, an OSA 3 344, and an outer area 3 345.

In the write-once disc 300, a replacement data block of each recording layer is recorded in the same recording layer for the defective data block that is to be replaced. A replacement data block substituting for a defective data block in L0 310 is recorded in L0 310, a replacement data block substituting for a defective data block in L1 320 is recorded in L1 320, a replacement data block substituting for a defective data block in L2 330 is recorded in L2 330, and a replacement data block substituting for a defective data block in L3 340 is recorded in L3 340.

A replacement data block 317 and a replacement data block 319 are recorded in the OSA0 314 of L0 310. The replacement blocks 317 and 319 substitute for a defective data block 316 and a defective data block 318 detected in the user data area 313 of L0 310. A replacement data block 327 and a replacement data block 329 are recorded in the ISA 1 322 and OSA 1 324 of L1 320. The replacement data blocks 327 and 329 substitute for a defective data block 326 and a defective data block 328 detected in the user data area 323 of L1 320, respectively. A replacement data block 337 and a replacement data block 339 are recorded in ISA 2 332 and OSA 2 334 of L2 330, respectively. The replacement data blocks 337 and 339 substitute for a defective data block 338 and a defective data block 336 detected in the user data area 333 of L2 330, respectively. A replacement data block 347 and a replacement data block 349 are recorded in the ISA 3 342 of L3 340. The replacement blocks 347 and 347 substitute for a defective data block 346 and a defective data block 348 detected in the user data area 343 of L3 340, respectively.

In the write-once disc 300, a replacement data block substituting for a defective data block generated in a recording layer is recorded in the same recording layer as the re-recording information storage medium. However, a temporary defect list storing information about a defective data block and a replacement data block cannot be updated in the same location because re-recording is not possible in the write-once disc 300. Accordingly, an area in which temporary disc management information can be updated may be employed before the write-once information storage medium is finalized. A temporary disc management area (TDMA) may be utilized as a space to update the temporary disc management information. The TDMA can be located in a lead out area and/or a lead in area of the write-once disc 300. When data recording is terminated and the temporary disc management area (TDMA) is finalized, temporary disc definition structure (TDDS) information, temporary defect list (TDFL) information, space bit map (SBM) information, etc., which are effective in the TDMA, are recorded in an inner area, an inner spare area, an outer spare area, and/or an outer area of a disc management area (DMA) (not shown).

The write-once disc 300 includes TDMAs 350 through 361. A TDFL is recorded in the TDMAs 350 through 362 in a TDMS update unit as described below.

In order to use the write-once disc 300 for reproduction without further recording data, the last TDFL out of the TDMAs 350 through 361 is recorded in the DMA when finalizing the write-once information storage medium. As illustrated in FIG. 3, the last TDFL out of the TDMAs 350 through 361 recorded in the DMA is a DFL 370.

Defect information containing information about a defective data block and replacement data block, i.e., a DFL, is recorded in an inner area and outer area of each recording layer. The DFL 370 is recorded in the inner area 311 of L0 310. The DFL 370 includes DFL0 371 through DFLn 373. The DFL0 371 through the DFLn 373 are defect lists having the same contents. The DFL0 371 through the DFLn 373 are repeatedly included in order to increase the reliability of information. According to other aspects of the invention, only one DFL may be included in the DFL 370. The DFL0 371 includes a DFL of L0 381, a DFL of L1 382, a DFL of L2 383, and a DFL of L3 384.

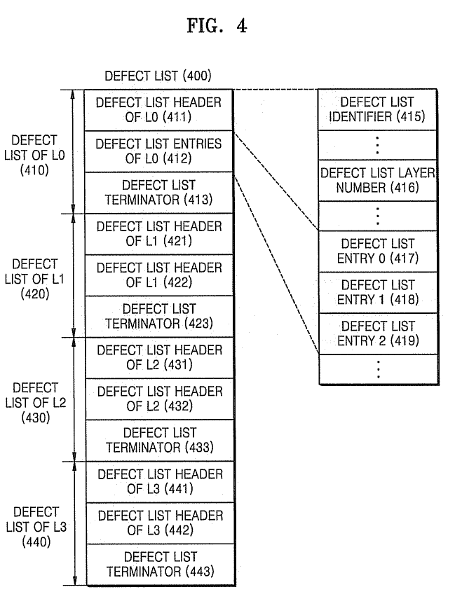

FIG. 4 illustrates a DFL 400 according to an embodiment of the present invention. The DFL 400 includes a DFL of L0 410, a DFL of L1 420, a DFL of L2 430, and a DFL of L3 440.

The DFL of L0 410 includes a defect list header of L0 411, defect list entries of L0 412, and a defect list terminator 413. The defect list header of L0 includes a defect list identifier 415 and a defect list layer number 416. Since the defect list header 411 includes the defect list layer number 416, a recording and/or reproducing apparatus can quickly find a DFL of each recording layer from the DFL 400, and only a DFL that requires an update is updated.

The defect list entries of L0 412 includes a defect list entry 0 417, a defect list entry 1 418, and a defect list entry 2 419. Each defect list entry includes address information regarding a defective data block and a replacement data block. Each defect list entry may further include state information about a defect. A defect list entry may not exist in an initial state where defect information is not yet registered.

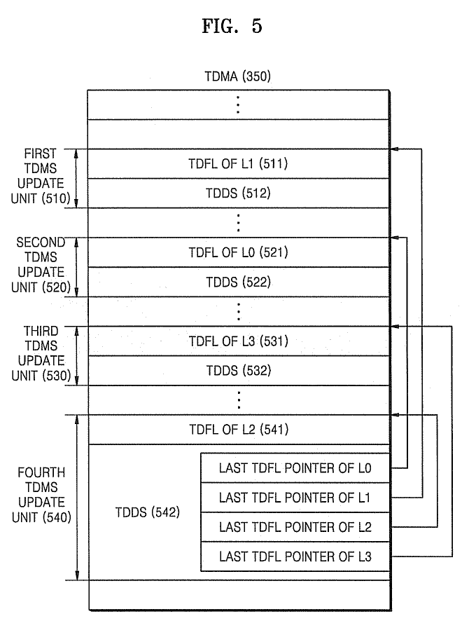

FIG. 5 illustrates the TDMA 350 according to an embodiment of the present invention. A TDFL containing information about a temporary defect, a TDDS containing information about a disc including address information regarding the TDFL, etc., an SBM having a recording state of data recorded in an information storage medium, etc., are recorded in the TDMA 350. The TDFL, TDDS, and SBM can be updated in various forms as update units.

Each TDMS update unit is formed of a TDFL and a TDDS for each recording layer. The TDMA 350 includes a first TDMS update unit 510, a second TDMS update unit 520, a third TDMS update unit 530, and a fourth TDMS update unit 540. The first TDMS update unit 510 includes a TDFL 511 of L1 and a TDDS 512, the second TDMS update unit 520 includes a TDFL 521 of L0 and a TDDS 522, the third TDMS update unit 530 includes a TDFL 531 of L3 and a TDDS 532, and the fourth TDMS update unit includes a TDFL 541 of L2 and a TDDS 542. A TDDS of the TDMS update unit that is recorded last includes the last TDFL pointers of all of the recording layers. In FIG. 5, the TDMS update unit that is recorded last is the fourth TDMS update unit 540, and the TDDS 542 of the fourth TDMS update unit 540 includes the last TDFL pointer of L2, the last TDFL pointer of L3, the last TDFL pointer of L0, and the last TDFL pointer of L1. By including the last TDFL pointers of each recording layer in the last TDMS update unit, a disc drive can obtain the latest defect information regarding each recording layer from the last TDMS update unit.

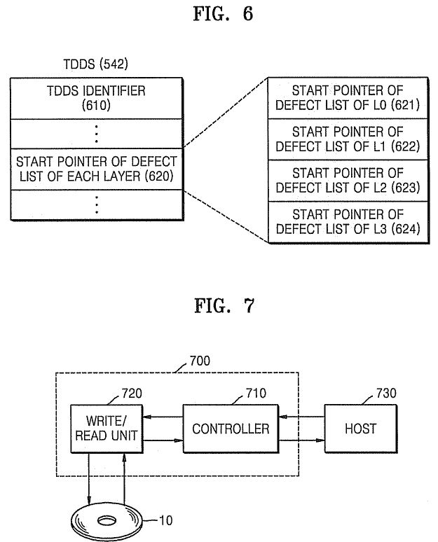

FIG. 6 illustrates the TDDS 542 of the TDMA 350 of FIG. 5 according to an embodiment of the present invention. The TDDS 542 includes a TDDS identifier 610 identifying a TDDS and a start pointer 620 of a defect list of each recording layer. The start pointer 620 includes a start pointer 621 of a defect list of L0, a start pointer 622 of a defect list of L1, a start pointer 623 of a defect list of L2, and a start pointer 624 of a defect list of L3. The TDDS 542 corresponds to a four layered disc having 4 recording layers; however, discs according to other aspects of the invention may have a different number of layers. The number of start pointers may vary according to the number of recording layers.

FIG. 7 is a schematic drawing of a recording/reproducing apparatus 700 according to an embodiment of the present invention. Here, recording/reproducing indicates recording and/or reproducing. Similarly, read/write indicates reading and/or writing. The recording/reproducing apparatus 700 is an apparatus that can read or reproduce data. The recording/reproducing apparatus 700 includes a write/read unit 720 and a controller 710. The write/read unit 720 records data to, and reads data from a disc 10, based on the control of the controller 710. The disc 10 is an information storage medium according to aspects of the present invention, such as the rewritable disc 200 or the write-once disc 300. The controller 710 controls the write/read unit 720 so that data is recorded in a predetermined record unit block or obtains effective data by processing data read by the write/read unit 720. The disc 10 is a multi-layered disc formed with at least two recording layers. Each recording layer includes a user data area to record user data and a spare area to recording replacement data that is to replace defective data from data recorded in the user data area.

The controller 710 controls the write/read unit 720 so that replacement data that is to replace defective data in the user data area of the recording layer is recorded in the same recording layer where the defective data is recorded.

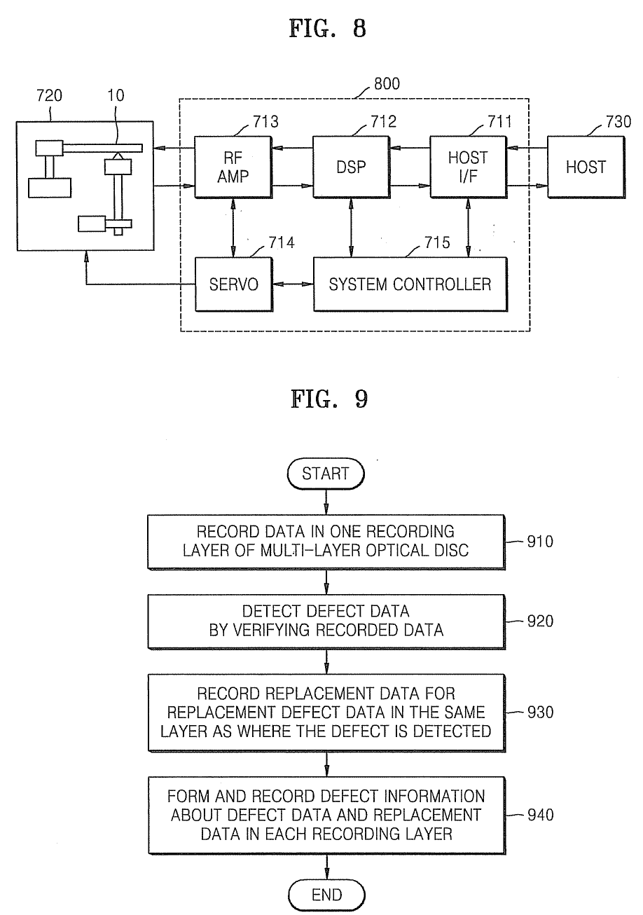

FIG. 8 is a diagram illustrating in detail the recording/reproducing apparatus 700. The recording/reproducing apparatus 700 includes an optical pickup as the write/read unit 720. The disc 10 is inserted into the optical pickup. The controller 710 of the recording/reproducing apparatus includes a host I/F (interface) 711, a digital signal processor (DSP) 712, a radio frequency (RF) amplifier (AMP) 713, a servo 714, and a system controller 715.

The system controller 715 controls replacement data that is to replace defective data generated in a user data area of a recording layer such that the replacement data is recorded in the same recording layer that the defective data is recorded. The system controller 715 also forms defect information containing information about the defective data and the replacement data in each recording layer, and the defect information includes information about the recording layer.

If the disc 10 is a write-once information storage medium (such as write-once disc 300), the disc 10 includes a temporary disc management area for temporary disc management of the write-once information storage medium. The system controller 715 records temporary defect information containing information about the defective data and the replacement data in the same recording layer that the defective data is recorded, and controls address information regarding the temporary defect information for each recording layer that is to be recorded in the temporary disc management area.

The system controller 715 further controls the write/read unit 720 so that a TDMS update unit is recorded in the temporary disc management area 350 as temporary disc management information for temporary disc management. The TDMS update unit may include a temporary defect list containing temporary defect information regarding a certain recording layer and a temporary disc definition structure containing a pointer indicating a location of the last temporary defect list of each recording layer (such as the TDDS 542 illustrated in FIG. 6.)

The DSP 712 generates an error correction (ECC) block by adding additional data, such as a parity bit, to data that is to be recorded for error correction and performs an ECC encoding, and modulates the ECC block by a predetermined method. The RF AMP 713 changes data outputted from the DSP 712 into an RF signal. The write/read unit 720 records the RF signal outputted from the RF AMP 713 on the disc 10. The servo 714 servo-controls the write/read unit 720 by receiving a command required for servo-control from the system controller 715.

The host I/F 711 receives a reproduce command from the host 730 during reproduction, The system controller 715 then performs an initiation required for reproduction. The system controller 715 checks whether data that is to be reproduced is included in the defect list. If the data is defective data registered in the defect list, the system controller 715 controls the write/read unit 720 so that substitution data corresponding to the defective data block is read from the same recording layer that the defective data block is recorded. The system controller 715 obtains an identifier of the defect list, a layer number of the defect list, at least one defect list entry from the defect list, and obtains address information regarding the defective data and the replacement data from each defect list entry.

The optical pickup radiates a laser beam on the disc 10 and outputs an optical signal obtained by collecting laser beam reflected from the disc 10. The RF AMP 713 changes the optical signal outputted from the optical pickup to an RF signal and provides modulated data obtained from the RF signal to the DSP 712 while providing a servo signal obtained from the RF signal to the servo 714. The server signal is used to control the servo 714. The DSP 712 demodulates the modulated data and outputs data obtained via an ECC error correction method. The servo 714 performs servo-control on the optical pickup by receiving the servo signal from the RF AMP 713 and a command required for servo-control from the system controller 715. The host I/F 711 transmits data received from the DSP 712 to the host 730.

FIG. 9 is a flowchart illustrating a recording technique according to an embodiment of the present invention. In operation 910, data is recorded in a user data area of one recording layer of a multi-layer optical disc formed with at least two recording layers. In operation 920, defective data is detected by verifying the recorded data. In operation 930, replacement data substituting for the defective data is recorded in a spare area of the same recording layer as where the defective data is detected. In operation 940, defect information about the defective data and the replacement data is formed in each recording layer and recorded in the multi-layer optical disc.

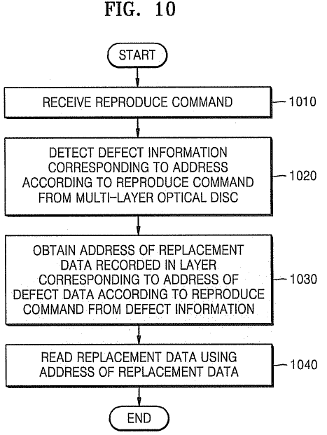

FIG. 10 is a flowchart illustrating a reproducing method according to an embodiment of the present invention. Upon receiving a data reproduce command from a host in operation 1010, defect information corresponding to data address according to the data reproduce command is read from a multi-layer optical disc in operation 1020.

An address of a replacement data block corresponding to a defective data block of the data address according to the data reproduce command is obtained from the defect information in operation 1030. The address of the replacement data block corresponding to the defective data block is in the same recording layer as the defective data. If data according to the data reproduce command is not defective data, that data is not recorded in defect information, and the data can be reproduced using the conventional method of reproducing data. In operation 1040, the replacement data block is read from the same recording layer where the defective data exists, using the address of the obtained replacement data block.

Recording and reproducing methods according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, by locating a defective data block and a replacement data block in the same recording layer in a multi-layer optical disc, the searching for an optical spot is generated in the same recording layer while recording/reproducing the defective data block. This prevents a layer jump to another layer and reduces data reproduction time, since the time to move to another layer is reduced. The time for renewing and/or revising a defect list is reduced by forming a defect list for each recording layer and independently renewing and revising the defect lists.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium having a plurality of recording layers used by a recording/reproducing apparatus, the information storage medium comprising:
a user data area to record user data; and
a spare area to record replacement data that replaces a defective data block detected in the user data area,
wherein the replacement data is recorded in the same recording layer as the defective data block.

2. The information storage medium of claim 1, wherein defect information containing information about the defective data block and the replacement data is recorded in at least one recording layer.

3. The information storage medium of claim 2, wherein the defect information includes information about the recording layer in which the defect information is recorded.

4. The information storage medium of claim 2, wherein the defect information comprises:
an identifier of a defect list;
a layer number of the defect list; and
at least one defect list entry;
wherein each defect list entry comprises address information regarding the defective data block and the replacement data.

5. The information storage medium of claim 1, wherein:
the information storage medium is a write-once information storage medium and further comprises a temporary disc management area for temporary disc management;
temporary defect information about the defective data block and the replacement data is recorded in the same recording layer that the defective data block is detected; and
the temporary disc management area comprises address information regarding the temporary defect information in each recording layer.

6. The information storage medium of claim 5, wherein:
the temporary disc management area comprises a temporary disc management structure (TDMS) update unit as temporary disc management information; and
the TDMS update unit comprises a temporary defect list having temporary defect information regarding one of the plurality of recording layers, and a temporary disc definition structure having a pointer indicating a location of the last temporary defect list of each recording layer.

7. A recording apparatus to record data in an information storage medium having a plurality of recording layers, each comprising a user data area to record user data and a spare area to record replacement data that replaces a defective data block when a defect occurs in data recorded in the user data area, the recording apparatus comprising:
a write unit to write data to the information storage medium; and
a controller to control the write unit to write the replacement data in the same recording layer as the defective data block.

8. The recording apparatus of claim 7, wherein the controller further controls the write unit so that defect information containing information about the defective data block and the replacement data is formed in each recording layer and recorded in at least one recording layer.

9. The recording apparatus of claim 8, wherein the controller inserts information about the recording layer in which the defect information is recorded in the defect information.

10. The recording apparatus of claim 8, wherein the controller inserts an identification of a defect list, a layer number of the defect list, and at least one defect list entry in the defect information, and inserts address information regarding the defective data block and the replacement data in each defect list entry.

11. The recording apparatus of claim 7, wherein:
the information storage medium is a write-once information storage medium and further comprises a temporary disc management area for temporary disc management; and
the controller controls the write unit so that temporary defect information containing information about the defective data block and the replacement data is recorded in the same recording layer that the defective data block is recorded, and address information regarding the temporary defect information for each recording layer is recorded in the temporary disc management area.

12. The recording apparatus of claim 11, wherein:
the controller controls the write unit to record a temporary disc management structure (TDMS) update unit in the temporary disc management area as temporary disc management information; and
the controller inserts into the TDMS update unit a temporary defect list comprising temporary defect information about one of the plurality of recording layers and a temporary disc definition structure comprising a pointer indicating a location of the last temporary defect list of each recording layer.

13. A reproducing apparatus to reproduce data in an information storage medium having a plurality of recording layers, each comprising a user data area to record user data and a spare area to record replacement data that replaces a defective data block when a defect occurs in data recorded in the user data area, the reproducing apparatus comprising:
a read unit to read data from the information storage medium; and
a controller to control the read unit to read replacement data corresponding to a defective data block from the same recording layer having the defective data block if the data that is to be reproduced is in the defective data block.

14. The reproducing apparatus of claim 13, wherein the controller further controls the read unit so that defect information containing information about the defective data block and the replacement data is formed in each recording layer.

15. The reproducing apparatus of claim 14, wherein the controller obtains information about the recording layer in which the defect information is recorded from the defect information.

16. The reproducing apparatus of claim 14, wherein the controller obtains an identification of a defect list, a layer number of the defect list, and at least one defect list entry from the defect information, and obtains address information regarding the defective data block and the replacement data from the defect list entry.

17. The reproducing apparatus of claim 13, wherein:
the information storage medium is a write-once information storage medium and further comprises a temporary disc management area for temporary disc management; and
the controller further controls the read unit so that temporary defect information containing information about the defective data block and the replacement data is read from the same recording layer having the defective data block and address information regarding the temporary defect information for each recording layer is read from the temporary disc management area.

18. The reproducing apparatus of claim 17, wherein:
the controller controls the read unit so that a temporary disc management structure (TDMS) update unit is read from the temporary disc management area as temporary disc management information; and
the controller obtains, from the TDMS update unit, a temporary defect list comprising temporary defect information regarding one of the plurality of recording layers and a temporary disc definition structure comprising a pointer indicating a location of the last temporary defect list of each recording layer.

19. A recording method that records data in an information storage medium having a plurality of recording layers, each comprising a user data area to record user data and a spare area to record replacement data that replaces a defective data block when a defect occurs in data recorded in the user data area, the recording method comprising:
detecting the defective data block in the user data area; and
recording the replacement data in the same recording layer as the defective data block.

20. The recording method of claim 19, further comprising forming defect information containing information about the defective data block and the replacement data and recording the defect information in at least one recording layer.

21. The recording method of claim 20, wherein the defect information comprises information about the recording layer in which the defect information is recorded.

22. The recording method of claim 20, wherein:
the defect information comprises an identification of a defect list, a layer number of the defect list, and at least one defect list entry; and
each defect list entry comprises address information regarding the defective data block and the replacement data.

23. The recording method of claim 19, wherein the recording method further comprises:
recording temporary defect information containing information about the defective data block and the replacement data in the same recording layer where the defective data block is recorded; and
recording address information regarding the temporary defect information for each recording layer in the temporary disc management area.

24. The recording method of claim 23, further comprising:
recording a temporary disc management structure (TDMS) update unit in the temporary disc management area as temporary disc management information;
wherein the TDMS update unit comprises a temporary defect list having temporary defect information regarding one of the plurality of recording layers and a temporary disc definition structure having a pointer indicating a location of the last temporary defect list of each recording layer.

25. A reproducing method to reproduce data in an information storage medium having a plurality of recording layers, each comprising a user data area to record user data and a spare area to record replacement data that replaces a defective data block when a defect occurs in data recorded in the user data area, the reproducing method comprising:
reading replacement data corresponding to the defective data block from the same recording layer having the defective data block, when data that is to be reproduced is from the defective data block.

26. The reproducing method of claim 25, wherein defect information containing information about the defective data block and the replacement data is formed in each recording layer.

27. The reproducing method of claim 26, further comprising:
obtaining information about the recording layer in which the defect information is recorded from the defect information.

28. The reproducing method of claim 26, further comprising:
obtaining an identification of the defect list, a layer number of the defect list, and at least one defect list entry from the defect information; and
obtaining address information regarding the defective data block and the replacement data from each defect list entry.

29. The reproducing method of claim 25, wherein the reproducing method further comprises:
reading temporary defect information containing information about the defective data block and the replacement data from the same recording layer where the defective data block is recorded; and
reading address information regarding the temporary defect information for each recording layer from the temporary disc management area.

30. The reproducing method of claim 29, further comprising:
reading a temporary disc management structure (TDMS) update unit from the temporary disc management area as temporary disc management information for a temporary disc management; and
obtaining from the TDMS update unit a temporary defect list comprising temporary defect information regarding one of the plurality of recording layers and a temporary disc definition structure comprising a pointer indicating the last temporary defect list of each recording layer.
